(19) United States
(12) Patent Application Publication
(10) Pub. No.: US 2013/0263016 A1
(43) Pub. Date: Oct. 3, 2013

(54) METHOD AND APPARATUS FOR LOCATION TAGGED USER INTERFACE FOR MEDIA SHARING

(71) Applicants: Arto Juhani Lehtiniemi, Lempaala (FI); Juha Henrik Arrasvuori, Tampere (FI); Antti Johannes Eronen, Tampere (FI)

(72) Inventors: Arto Juhani Lehtiniemi, Lempaala (FI); Juha Henrik Arrasvuori, Tampere (FI); Antti Johannes Eronen, Tampere (FI)

(73) Assignee: Nokia Corporation, Espoo (FI)

(21) Appl. No.: 13/431,405

(22) Filed: Mar. 27, 2012

(51) Int. Cl. G06F 3/01; G06F 15/16

(52) U.S. Cl. 715/753

(57) ABSTRACT

An approach is provided for a location-tagged user interface for media sharing. A media service platform determines one or more media profiles associated with at least one point of interest. The media service platform also causes, at least in part, a rendering of at least user interface element in association with at least one representation of the at least one point of interest. The user interface element represents, at least in part, the one or more media profiles. The media service platform further causes, at least in part, a rendering of at least one input connection component, at least one output connection component, or a combination thereof for interacting with the at least one user interface element, the one or more media profiles, or a combination thereof.

### BACKGROUND

Service providers and device manufacturers (e.g., wireless, cellular, etc.) are continually challenged to deliver value and convenience to consumers by, for example, providing compelling network services. One area of interest has been the development of location-based services (e.g., navigation services, mapping services, augmented reality applications, etc.) that have greatly increased in popularity, functionality, and content. Augmented reality and mixed reality applications allow users to see a view of the physical world merged with virtual objects in real time. Mapping applications further allow such virtual objects to be annotated to location information. However, with this increase in the available content and functions of these services, service providers and device manufacturers face significant challenges to support users to share media content and/or scrobble data describing media consumed at particular locations.

### SOME EXAMPLE EMBODIMENTS

Therefore, there is a need for an approach for providing a location-tagged user interface for media sharing in order to overcome the above mentioned and other issues associated with sharing media profiles and/or media information tagged to locations.

According to one embodiment, a method comprises determining one or more media profiles associated with at least one point of interest. The method also comprises causing, at least in part, a rendering of at least user interface element in association with at least one representation of the at least one point of interest, wherein the user interface element represents, at least in part, the one or more media profiles. The method further comprises causing, at least in part, a rendering of at least one input connection component, at least one output connection component, or a combination thereof for interacting with the at least one user interface element, the one or more media profiles, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more media profiles associated with at least one point of interest. The apparatus is also caused to cause, at least in part, a rendering of at least user interface element in association with at least one representation of the at least one point of interest, wherein the user interface element represents, at least in part, the one or more media profiles. The apparatus is further caused to cause, at least in part, a rendering of at least one input connection component, at least one output connection component, or a combination thereof for interacting with the at least one user interface element, the one or more media profiles, or a combination thereof.

According to another embodiment, a computer-readable storage medium carries one or more sequences of one or more instructions which, when executed by one or more processors, cause, at least in part, an apparatus to determine one or more media profiles associated with at least one point of interest. The apparatus is also caused to cause, at least in part, a rendering of at least user interface element in association with at least one representation of the at least one point of interest, wherein the user interface element represents, at least in part, the one or more media profiles. The apparatus is further caused to cause, at least in part, a rendering of at least one input connection component, at least one output connection component, or a combination thereof for interacting with the at least one user interface element, the one or more media profiles, or a combination thereof.

According to another embodiment, an apparatus comprises means for determining one or more media profiles associated with at least one point of interest. The apparatus also comprises means for causing, at least in part, a rendering of at least user interface element in association with at least one representation of the at least one point of interest, wherein the user interface element represents, at least in part, the one or more media profiles. The apparatus further comprises means for causing, at least in part, a rendering of at least one input connection component, at least one output connection component, or a combination thereof for interacting with the at least one user interface element, the one or more media profiles, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a location-tagged user interface for media sharing, according to one embodiment;

FIG. 2 is a diagram of the components of a media service platform, according to one embodiment;

FIG. 3 shows a flowchart of a process for providing a location-tagged user interface for media sharing, according to one embodiment;

FIGS. 4A-4D show presentation of media-sharing user interface elements on buildings, according to various embodiments;

FIG. 5 is diagram of a user interface utilized media processing effects, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing a location-tagged user interface for media sharing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

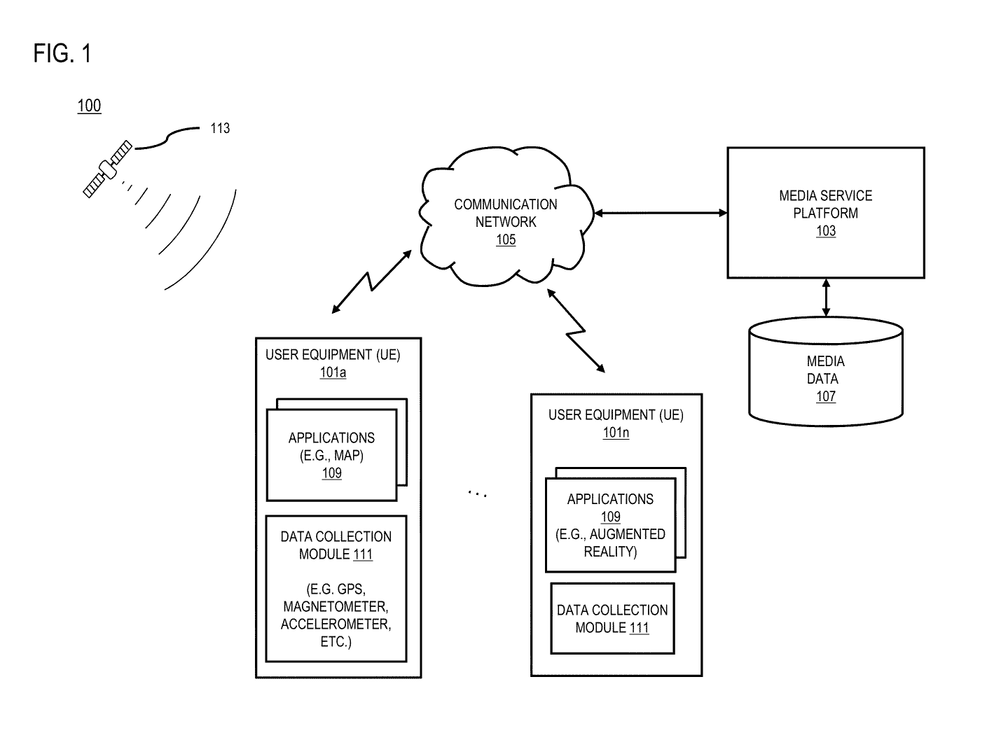

FIG. 1 is a diagram of a system capable of providing a location-tagged user interface for media sharing, according to one embodiment. The existing location-based media sharing services do not allow a user to visually connect a user device (e.g., a mobile phone, a media player, etc.) to a location for accessing media profiles and media information associated with the location (e.g., playlists and/or media content consumed there and/or tagged there, etc.). By way of example, there is a collaborative location-based service for users to upload geo-tagged audio clips of city background sounds, which then are presented as dots on a map. The users can draw routes to create a remix of the audio clips.

To address the above mentioned problems, a system 100 of FIG. 1 introduces the capability to provide a location-tagged user interface for media sharing. The system 100 applies augmented reality (AR) and mixed reality (MR) services and applications to visually connect a user device to a location for accessing media profiles and media information associated with the location. AR allows a graphical user interface (GUI) to show a user's view of the real world overlaid with additional visual information. MR allows for the merging of real and virtual worlds to produce visualizations and new environments. In MR, physical and digital objects can co-exist and interact in real time. Thus, MR can be a mix of reality, AR, virtual reality, or a combination thereof. Such applications allows for the association of one or more media profiles to a location (e.g., a point of interest), or to one or more structures (e.g., buildings) in the location, wherein the structure in a virtual world may be presented as a two dimensional (2D) or three dimensional (3D) object. The one or more media profiles may be shared with other users. The media profile owner can be a user, a company, an advertiser, etc., and they may need approval of the POI owner to tag the media profiles thereon.

In one embodiment, the system 100 renders a GUI element in a representation of a point of interest (e.g., a point on a map, etc.). The user interface element represents a media profile (e.g., a billboard of Kim's playlist). In addition, the system 100 renders at least one input connection component (e.g., an input icon/tap in a GUI of a user device), at least one output connection component (e.g., an output icon/tap in the GUI element in the POI representation) for interacting with the user interface element rendered in the POI representation, the media profile, or a combination thereof. The representation of a POI may be a portion of a pre-recorded or live panoramic image, a portion of a pre-recorded or live camera view, etc. By manipulating the input icon/tap and the output icon/tap on the GUIs, the user can download/upload the media profile and/or media information (e.g., one or more songs/movies in Kim's playlist, etc.) to the user device, rendering the media profile and/or media information at the user device, rendering the media profile and/or media information with thematic effects related to the POI. The theme may be a unifying subject or idea of a type of media, e.g., a color, a word, a phrase, a tune, a melody, a song, an image, a movie, a genre, an object, a person, a character, an animal, etc. related to the point of interest. By way of example, if the point of interest is the International Spy Museum, the theme may be secret agents, 007, espionage, cover, pass code, CIA, KGB, cold war, cyber spying, surveillance aircraft, etc., and the thematic effect may be converting a film into black and white and adding a pass code of “007” for viewing the film.

In some embodiments, the thematic effects are related to architectural acoustics of the POI, such as applying dynamic equalization, phase manipulation and harmonic synthesis of typically high frequency signals based upon the architectural features. The system 100 can control sound and vibrations within buildings when playing back media (e.g., a song/movie in Kim's playlist) selected by the user. The architectural acoustics can be applied to any area or space, such as opera houses, concert halls, office spaces, bathrooms, ventilation ducts, etc. By way of example, the system 100 can deduce from the size and shape of the building extracted from the related media profile to vary the reverberation it creates when rendering the selected song/movie in Kim's playlist. For example, the system 100 may create an impulse response modeling the acoustic characteristics of a space with the size and shape of the building and convolve the corresponding audio track with the impulse response. Alternatively, the system 100 may select a measured impulse response from a set of measured impulse responses such that the space where the measurement was made resembles the building in the media profile.

In some embodiments, the thematic effects are related to environmental acoustics of the POI. The system 100 can control sound and vibrations in an outdoor environment at the tagged location, when playing back media (e.g., a song/movie in Kim's playlist) selected by the user. The system 100 can include or remove sounds generated by animal, instruments, machines, nature, people, traffic, aircraft, industrial equipment, etc.

In some embodiments, there are several media files tagged to the POI. The system 100 may determine one or more media files to present in the GUI element in the POI representation based on physical proximity between the user device and users owning the media profiles (or proximity between the user and the POI), social proximity between a user of the user device and the users owning the media profiles, media profile similarity, or a combination thereof. The proximity of social networks can be defined by groups, levels, etc. By way of examples, the media profile owner allows other users in 1 mile radius of the POI to view his/her media profile, the media profile owner allows other users in 1 mile radius of the media profile owner's currently location to view his/her media profile, the media profile owner allows his high school classmates to view his/her media profile, the media profile owner allows his Facebook® friends to view his/her media profile, or the media profile owner allows any people who listen to punk rock to view his/her media profile.

According to some embodiments, the POI representation may be a two dimensional or three dimensional representation of the POI (e.g., a point on a map), one or more structures (e.g., a building, tree, street, wall, landscape, etc.) associated with the POI, or a combination thereof. The structures can be physical structures in the real world or physical environment, or a corresponding virtual structure in a virtual reality world. A representation of a physical structure can be via an image of the structure. With this approach users can view where the media profile is associated as it is displayed over a POI representation (e.g., a panoramic view and/or camera view of the POI).

In other embodiments, the media profiles contain geometric details and textures representing the actual structures. In these cases, the system 100 can deduce from the size and shape of the building to vary the audio and/or video effects it creates when rendering the selected thematic effects related to the POI, such as karaoke effects on a song in Kim's playlist (e.g., mixed with the user's voice), or augmented/virtual reality effects on a game or training software in Kim's playlist (e.g., mixed with the user's avatar or actual image).

By way of example, in response to a user's connection to a karaoke effect icon of a media profile tagged to the American Idol's Hollywood stage and a user's selection of a song “I Will Always Love You”, the system 100 simulates the background music of “I Will Always Love You” as if playing in the American Idol's Hollywood stage. Concurrently, the system 100 collects the user's singing voice of “I Will Always Love You,” modifies the voice as if singing in the American Idol's Hollywood stage, and mixes the modified voice with the background music of the song. The karaoke mixture sounds very realistic to the user and significantly increases the utility of the media profile.

As another example, in response to a user's connection to an augmented reality effect icon of a media profile tagged to the Kennedy Center Concert Hall and a user's selection of user's electrical guitar playing video clip, the system 100 simulates the color or texture of the user's image and sound of playing the piano as in the Kennedy Center Concert Hall, and inserts the simulation into a video clip of a band playing in the Concert Hall to a video as if the user is playing electrical guitar in the Concert Hall with the band. In another embodiment, the system 100 apply an augmented reality effect in a game such that an avatar of the user and the avatars of the band are presented as if they are playing together in the Concert Hall, when the user is playing the electrical guitar game.

In one embodiment, a three dimensional (3D) perspective can be utilized that makes the media profile to become part of the view instead of an overlay of it. In this manner, the media profile can be integrated with a surface (e.g., a building facade) of the structure. To present such a GUI, one or more user equipment (UEs) 101a-101n can retrieve media profiles associated with a POI. The UEs 101a-101n can then retrieve a model of the structure and cause rendering of the media profile based on features of one or more surfaces of the structure in the GUI.

In another embodiment, the associated media profile or media information can be packaged as a campaign data pack and delivered to the user device or other rendering device at the beginning of the rendering of the 3D artifact. In addition or alternatively, the media profile or media information can be delivered respectively per waypoint when the 3D artifact is moved and rendered at the corresponding waypoint. In some embodiments, the media profile or media information is adaptively changed over time and/or location (e.g., waypoints) while the user is (1) viewing the panoramic view; (2) browsing street level scenes; and/or (3) using the camera viewfinder to show an AR scene at one of the waypoints tagged with the media profile. In one embodiment, the change of the media profile or media information can be configured by an editing tool based, at least in part, on some parameters or threshold values like distance, size, etc.

In one embodiment, user equipment 101a-101n of FIG. 1 can present the GUI to users. In certain embodiments, the processing and/or rendering of the media profile or media information may occur on the UEs 101a-101n. In other embodiments, some or all of the processing may occur on one or more media service platforms 103 that provide one or more media sharing services. In certain embodiments, a media sharing service provides a user interface for media sharing (e.g., media profiles, media information, entertainment, advertisement, etc.) on a structure at a point of interest. The provided media may be associated with the geographical location of the structure, position of the features of the structure, orientation information of the UE 101a-101n, etc. The UEs 101a-101n and the media service platform 103 can communicate via a communication network 105. In certain embodiments, the media service platform 103 may additionally include media data 107 that can include media (e.g., video, audio, images, texts, etc.) associated with particular POIs. This media data 107 can include media from one or more users of UEs 101a-101n and/or commercial users generating the content. In one example, commercial and/or individual users can generate panoramic images of area by following specific paths or streets. These panoramic images may additionally be stitched together to generate a seamless image. Further, panoramic images can be used to generate images of a locality, for example, an urban environment such as a city. In certain embodiments, the media data 107 can be broken up into one or more databases.

Moreover, the media data 107 can include map information. Map information may include maps, satellite images, street and path information, point of interest (POI) information, signing information associated with maps, objects and structures associated with the maps, information about people and the locations of people, coordinate information associated with the information, etc., or a combination thereof. A POI can be a specific point location that a person may, for instance, find interesting or useful. Examples of POIs can include an airport, a bakery, a dam, a landmark, a restaurant, a hotel, a building, a park, the location of a person, or any point interesting, useful, or significant in some way. In some embodiments, the map information and the maps presented to the user may be a simulated 3D environment. In certain embodiments, the simulated 3D environment is a 3D model created to approximate the locations of streets, buildings, features, etc. of an area. This model can then be used to render the location from virtually any angle or perspective for display on the UEs 101a-101n. Further, in certain embodiments, the GUI presented to the user may be based on a combination of real world images (e.g., a camera view of the UEs 101a-101n or a panoramic image) and the 3D model. The 3D model can include one or more 3D structure models (e.g., models of buildings, trees, signs, billboards, lampposts, etc.). These 3D structure models can further comprise one or more other component structure models (e.g., a building can include four wall component models; a sign can include a sign component model and a post component model, etc.). Each 3D structure model can be associated with a particular location (e.g., global positioning system (GPS) coordinates or other location coordinates, which may or may not be associated with the real world) and can be identified using one or more identifier. A data structure can be utilized to associate the identifier and the location with a comprehensive 3D map model of a physical environment (e.g., a city, the world, etc.). A subset or the set of data can be stored on a memory of the UEs 101a-101n.

As discussed previously, the 3D structure model may be associated with certain waypoints, paths, etc. within the virtual environment that may or may not correspond to counterparts in the physical environment. In this way, the media profile may be selected to correspond with the located waypoint/POI.

In one embodiment, the media data 107 may include, apart from the 360 degree panoramic street imagery, a 3D model of an entire city. The 3D model may be created based on the Light Detection and Ranging (LIDAR) technology which is an optical remote sensing technology and can measure distances to a target structure or other features of the structure by illuminating the target with light. Additionally, the intensity of the returning light and the distribution of measured distances can be used to identify different kinds of surfaces. Therefore, the 3D morphology of the ground at any point (terrain), and the geometry of the structures (e.g., buildings) can be determined in detail. Utilizing the 3D model provides the capability of highlighting structures, adding user interface elements to the structures, etc.

The user may use one or more applications 109 (e.g., thematic effect applications, a map application, a location services application, a content service application, etc.) on the UEs 101a-101n to provide media associated with one or more features of a structure to the user. The thematic effect applications may include a karaoke application, an augmented reality application, etc. In this manner, the user may activate an application 109. The application 109 can utilize a data collection module 111 to provide location and/or orientation of the UE 101. In certain embodiments, one or more GPS satellites 113 may be utilized in determining the location of the UE 101. Further, the data collection module 111 may include an image capture module, which may include a digital camera or other means for generating real world images. These images can include one or more structures (e.g., a building, tree, sign, car, truck, etc.). Further, these images can be presented to the user via the GUI. The UE 101 can determine a location of the UE 101, an orientation of the UE 101, or a combination thereof to present the content and/or to add additional content.

For example, the user may be presented a GUI including an image of a location. This image can be tied to the 3D world model (e.g., via a subset of the media data 107), wherein various media profiles associated with one or more features of the world model by media service platform 103 can be presented on the media to the user. The user may then select one or more presented media contents in order to view media profile or media information associated with the media content. For example, music playlist of a restaurant inside a building may be presented on the door or one a window of the building and user by connect to the output icon in the playlist to receive the playlist, one or more songs in the playlist, operation hours and contact information of the restaurant, etc. on the GUI.

In one embodiment, the media service platform 103 may provide an option to the user of UE 101 to select a location on the screen where the user would like to receive certain content or move the received contents around the GUI display. For example, the user may want to see a media profile tagged on a lower window or a higher window of a building or in the corner of the screen. The user may also be given an option to select the type of media content to receive, for example, jazz, classic, etc. that were played or being played in the restaurant.

In one embodiment, the options a user may be provided with, as for the location and/or the type of the media content, can be determined by the media service platform 103 based on various factors, rules, and policies set, for example, by the media profile owners and/or the content providers, real estate owners, city authorities, etc. For example, if a building owner saves certain locations on the virtual display of the building for his/her own media profiles; a user receiving the virtual display may not be allowed to tag/place any media profiles on those specific locations. In another example, the system 100 may determines which media profiles displayed where and when based on agreements among the media profile owners and the content providers.

In various embodiments, some of the permissions associated with the media profiles can be assigned by the user, for example, the user may select that the user's UE 101 is the only device allowed to receive the media profiles. In this scenario, the media profiles may be stored on the user's UE 101 and/or as part of the media data 107 (e.g., by transmitting the media profiles to the media service platform 103). Further, the permissions can be public, based on a key, a username and password authentication, based on whether the other users are part of a contact list of the user, or the like. In these scenarios, the UE 101 can transmit the media profiles and media information to the media service platform 103 for storing as part of the media data 107 or in another database associated with the media data 107. As such, the UE 101 can cause, at least in part, storage of the association of the media profiles and the POIs. In certain embodiments, media profiles can be visual or audio information that can be created by the user or associated by the user to the point and/or structure. A media profile may selectively include user profile data, scrobbling data, data of the POI or related structure, some or all of media content associated with the scrobbling data, comments/reviews/ratings regarding the user, the media content, social network data related to the media consumption and/or the POI/structure, etc. The user profile data may include a user name, a photo, a date of registration, a total number of media tracks played, etc. The social network data related to the media consumption and/or the POI/structure can include lists of friends, friends' playlists, weekly musical fans, favorite tags, groups, events, etc. All other related information for providing the media server is refereed as media information.

Scrobbling data include users' media consumption data, such as a list of top artists and media tracks, the 10 most recently played media tracks, music-listening habits tracked over time via local software or internet services, as counted events when songs or albums are played. By way of example, a user can build a media profile by listening to a personal music collection on a music player application on a computer or a mobile device with a scrobbler plug-in, or by listening to Last.fm® internet radio service. All songs played are added to a log from which personal top artist/track bar charts and musical recommendations are calculated.

In some embodiments, the system 100 presents a heat map with highlighted popular POIs, media profiles, UI elements, etc.

In certain embodiments, the media profiles and/or structures or their representing UI elements presented to the user via the GUI is filtered. Filtering may be advantageous if more than one media profile is associated with a structure or a certain feature of a structure. Filtering can be based on one or more criteria determined by users, real estate owners, content providers, authorities, etc. Furthermore, policies may be enforced to associate hierarchical priorities to the filters so that for example some filters override other filters under certain conditions, always, in absence of certain conditions, or a combination thereof. One criterion can include user preferences, for example, a preference selecting types (e.g., text, video, audio, images, messages, etc.) of media profiles to view or filter, one or more media service platforms 103 (e.g., the user or other users) to view or filter, etc. Another criterion for filtering can include removing media profiles from display by selecting the media profiles for removal (e.g., by selecting the media profiles via a touch enabled input and dragging to a waste basket). Moreover, the filtering criteria can be adaptive using an adaptive algorithm that changes behavior based on available media profiles and information (metadata) associated with media content. For example, a starter set of information or criteria can be presented and based on the starter set, the UE 101 or the media service platform 103 can determine other criteria based on the selected criteria. In a similar manner, the adaptive algorithm can take into account media profiles removed from view on the GUI. Additionally or alternatively, precedence on viewing media profiles (or GUI elements of the media profiles) that overlaps can be determined and stored with the media content. For example, a media profile may have the highest priority to be viewed because a user or a content provider may have paid for the priority. Then, criteria can be used to sort priorities of media profiles to be presented to the user in a view. In certain embodiments, the user, the content provider, the real estate owner of a combination thereof may be provided with the option to filter the media profiles based on time. By way of example, the user may be provided a scrolling option (e.g., a scroll bar) to allow the user to filter media profiles based on the time it was created or associated with the environment. Moreover, if media profiles that the user wishes to view are obstructed, the UE 101 can determine and recommend another perspective to more easily view the media profiles.

As shown in FIG. 1, the system 100 comprises one or more user equipment (UEs) 101a-101n having connectivity to media service platform via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101a-101n is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101a-101n can support any type of interface to the user (such as “wearable” circuitry, etc.).

By way of example, the UEs 101a-101n and the media service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

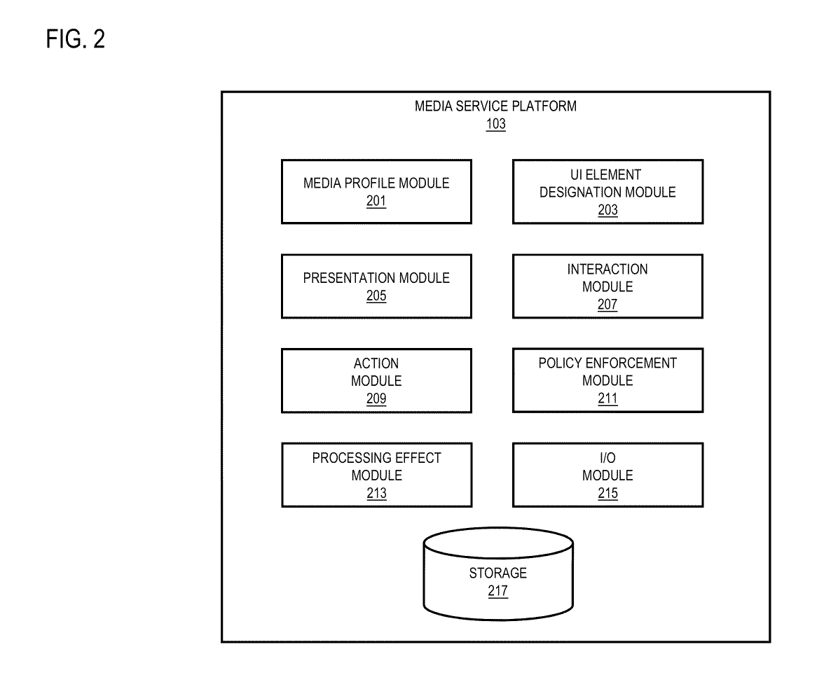

FIG. 2 is a diagram of the components of a media service platform, according to one embodiment. By way of example, the media service platform 103 includes one or more components for providing a location-tagged user interface for media sharing. It is contemplated that the functions of these components may be combined in one or more components or performed by other components of equivalent functionality. In this embodiment, the media service platform includes media profile module 201, UI element designation module 203, presentation module 205, interaction module 207, action module 209, policy enforcement module 211, processing effect module 213, I/O module 215, and storage 217.

In one embodiment, the media profile module 201, determines one or more media profiles placed/tagged to a POI or at least one structure (e.g., building, tree, wall, vehicle, etc.) associated with the POI. The determined structure may be a virtual presentation of a real world structure, a virtual structure generated without a counterpart in the real world (a car, truck, avatar, banner, etc.) or a combination thereof.

In one embodiment, the media profile module 201 processes or facilitates extracting information from the media profile to determine one or more features of the one or more representations of the POI or at least one structure. The features of the one or more structures may be doors, windows, columns, etc. as well as the dimensions, materials, colors of the structural components.

In one embodiment, the UI element designation module 203 causes designation of at least one input connection component (e.g., an input icon), at least one output connection component (e.g., an output icon), at least one connecting user interface element (e.g., a connection cable), one or more determined features (e.g., a billboard) as elements of a virtual display area (e.g., a window) within the representation of the ROI or at least one structure (e.g., a building). The designation of the features as elements of the virtual display may include accessing and retrieval of information associated with the structures and their features from a local or external database. In one embodiment, the one or more features represent, at least in part, one or more windows, one or more doors, one or more architectural features, or a combination thereof of the at least one structure.

In one embodiment, the presentation module 205 causes presentation of the at least one input connection component (e.g., an input icon), the at least one output connection component (e.g., an output icon), the at least one connecting user interface element (e.g., a connection cable), the one or more determined features (e.g., a billboard) as elements of the virtual display area (e.g., a window) within the representation of the ROI or at least one structure (e.g., a building). In another embodiment, the presentation module 205 causes presentation of one or more outputs of one or more applications (e.g., the media processing effects), one or more services, or a combination thereof in the virtual display area. The one or more applications and/or services may be activated by the user of UE 101a-101n (e.g., application 109), by media service platform 103, by a component of communication network 105 (not shown) or a combination thereof.

In one embodiment, the presentation module 205, processes and/or facilitates a processing of one or more renderings of the virtual display area, the one or more representations, the one or more features, or a combination thereof to depict media processing effects, a time of day, a theme, an environmental condition, or a combination thereof. The depiction of mode, theme or condition can attract viewer's attention.

In one embodiment, the presentation module 205 causes, presentation of at least a portion of one or more inputs, one or more outputs, one or more connecting cables, and one or more interactions among the inputs, outputs, and cables as determined by the interaction module 207, based upon user inputs.

In one embodiment, the interaction module 207 determines one or more representations of interactions among UI elements as directed via user manipulation of the UI elements. The interaction module 207 then causes rendering of the interaction by the presentation module 205, in which the one or more representations of the UI elements interact with the one or more representations of other UI elements, the one or more features, the virtual display area, as well as the presentation of connecting element, the one or more outputs, or a combination thereof. By way of example, the user connects a virtual cable from a playlist output on a building or other structure to a “playlist recommendations input” on a music player, and the presentation module 205 displays the interactions of the UI elements accordingly.

In one embodiment, the action module 209 determines what actions to take based, at least in part, on the interactions of the UI elements. The actions may include downloading or uploading media profiles and/or media information, playback media content associated with the media profiles and/or media information, rendering media content associated with the media profiles and/or media information with one or more media processing effects, etc.

In one embodiment, the policy enforcement module 211 receives an input for specifying one or more policies associated with the at least one structure, the one or more representations, the one or more features, or a combination thereof. In one embodiment, the policies received, stored and used by the policy enforcement module 211 may include information about available structures or available features of structures for associating contents with. This information may include a fixed fee or a conditional fee (based on time, date, content type, content size, etc.) for content presentation (e.g., media profiles, advertisement, etc.). In some other embodiments, the information about the available structures or features may include auctioning information and policies providing an option for content providers to bid and offer their suggested prices for the location. The auctioning policies may be provided by the building owners, advertisement agencies, etc.

The policy information may be previously stored in storage 217, and retrieved by the policy enforcement module 211 prior to presentation of outputs by the presentation module 205. In one embodiment, the presentation module 205 may query the policy enforcement module 211 for policies associated with the structures, representations, features or a combination thereof prior to the presentation of the one or more outputs and present the outputs based, at least in part, on the one or more policies received from the policy enforcement module 211.

The presentation module 205 causes presentation of UI elements in the virtual display area. The one or more applications and/or services may be activated by the user of UE 101a-101n (e.g., application 109), by media service platform 103, by a component of communication network 105 (not shown) or a combination thereof. Prior to the presentation of the UI elements, the policy enforcement module 211 may verify (and or modify) the output based on the policies associated with the content, the user, the virtual display area (e.g., the structure, the features of the structure) etc.

In one embodiment, the one or more outputs presented by the presentation module 205 may relate, at least in part, to advertising information, and the one or more policies provided by the policy enforcement module 211 may relate to a type of information to display, an extent of the virtual display area to allocate to the one or more outputs, pricing information, or a combination thereof.

In another embodiment, the processing effect module 213 determines what media content, building structural characteristics, etc. to render media processing effects based, at least in part, on one or more characteristics associated with the one or more UI elements, their interactions, the one or more waypoints, or a combination thereof. For example, the one or more characteristics may include the dimensions, the building material, etc. of a room in the building, media content associated with the POIs, and the like.

In one embodiment, the processing effect module 213 determines to modify one or more rendering characteristics of the one or more UI elements, the one or more features of the presentation of media content or media information associated with the media profiles, wherein the one or more characteristics include, at least in part, a lighting characteristic, a color, a bitmap overlay, an audio characteristic, a visual characteristic, or a combination thereof. It is noted that even though the virtual display is generated based on the structures of the real world and their features, however the digital characteristics of the virtual display enables various modifications on the features such as color, shape, appearance, lighting, etc. These modifications may affect the user experience and attract user's attention to a certain content, provided information, etc.

In one embodiment, the processing effect module 213 determines to generate at least one animation including the one or more other representations of the one or more UI elements determined by the interaction module 207, wherein the rendering of the interactions by the presentation module 205 includes, at least in part, the at least one animation, and wherein the animation relates, at least in part, to the media profile and/or the media information, POI information, UI elements, or a combination thereof.

In one embodiment, wherein the one or more UI elements or structures include a movable UI elements or structure, the processing effect module 213 determines one or more tags, one or more waypoints, or a combination thereof associated with the UI elements. The processing effect module 213 can then render one or more other representations based, at least in part, on the one or more tags, the one or more waypoints, or a combination thereof.

In some embodiments, the processing effect module 213 determines contextual information associated the UE 101, and then determines the media content to render on the user device based on the contextual information. By way of example, the contextual information may include, for instance, time of day, location, activity, etc. In other embodiments, the processing effect module 213 may vary the media content over time or location without specific reference to the context of the UE 101.

In one embodiment, the I/O module 215 causes, at least in part, rendering of media content including, at least in part, the one or more representations, one or more other representations, the one or more features determined by the media profile module 201, the virtual display area designated by the UI element designation module 203, the presentation of the one or more outputs by the presentation module 205, or a combination thereof. The I/O module 215 determines one or more areas of the rendered media content including, at least in part, a rendering artifact, a rendering consistency, or a combination thereof.

In one embodiment, the I/O module 215 may cause the presentation module 205, to present at least a portion of the one or more outputs, one or more other outputs, or a combination in the one or more areas.

In one embodiment, a content provider may, for example, add UI elements to the virtual representation of the real world and the interaction module 207 may generate interactions among the UI elements and the virtual representation of structures. For example, animated characters, objects, etc. may be added to the presented output to for example interact with other objects (e.g., as a game), advertisements (e.g., banners, etc.), etc. In these and other embodiments, the processing effect module 213 may activate applications 109 from the UE 101a-101n, other applications from storage 217, downloadable applications via communication network 105, or a combination thereof to generate and manipulate one or more animated objects.

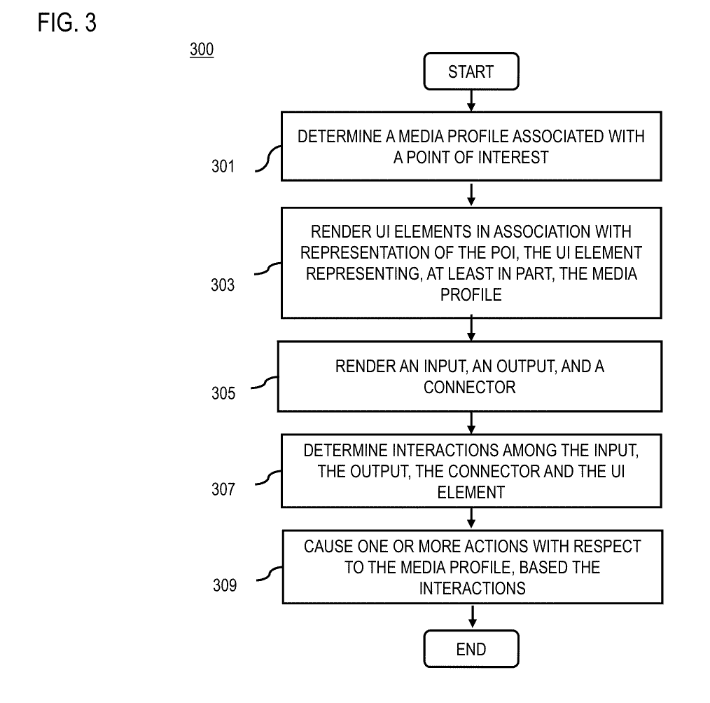

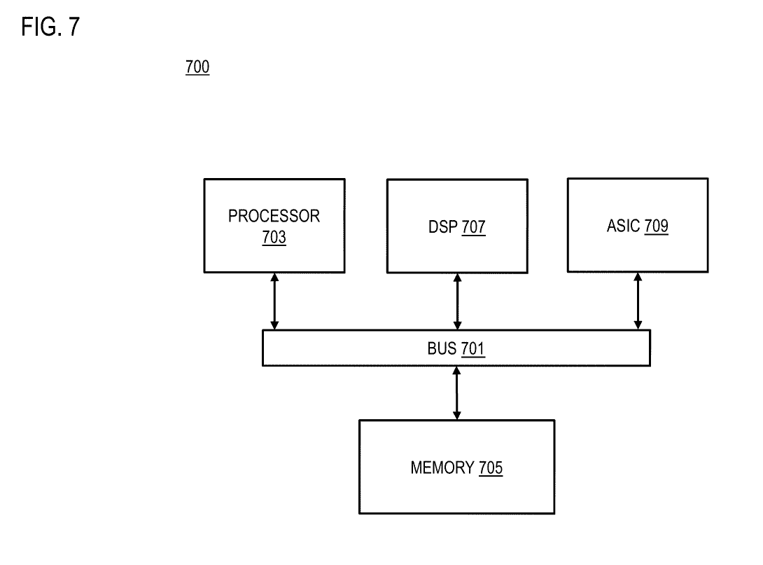

FIG. 3 shows a flowchart of a process for providing a location-tagged user interface for media sharing, according to one embodiment. In one embodiment, the media service platform 103 performs the process 300 and is implemented in, for instance, a chip set including a processor and a memory as shown in FIG. 7. It is contemplated that all or a portion of the functions of the media service platform 103 may be performed by the application 109 of the UE 101. In one embodiment, the media service platform 103 may communicate with a UE 101 as well as other devices connected on the communication network 105. For example, the media service platform 103 communicates with one or more UEs 101 via methods such as internet protocol, MMS, SMS, GPRS, or any other available communication method, in order to support UE 101 to perform all or a portion of the functions of the media service platform 103.

In step 301, the media service platform 103 determines one or more media profiles associated with at least one point of interest (e.g., any point on a map). A media profile may include one or more playlists, one or more media consumption preferences, etc. By way of example, users of a music service share information about music they consume in certain locations. The service gathers this information and makes it available to all users. The information may be bi-directional, so while a user shares his playlist with the service, the same user may also get recommendations of new songs to his playlist associated with a particular location.

In step 303, the media service platform 103 causes, at least in part, a rendering of at least user interface element in association with at least one representation of the at least one point of interest (e.g., a building, tree, wall, etc. located at the POI). The user interface element represents, at least in part, the one or more media profiles. The processing of the one or more representations may include utilizing various methods of image processing and/or image recognition in order to recognize the features of the one or more structures, such as doors, windows, columns, etc. of a building. The determined structure may be a virtual presentation of a real world structure, a virtual structure generated without a counterpart in the real world (e.g., an avatar, banner, etc.) or a combination thereof. The one or more representations may be associated with views of the at least one structure form different perspectives in a 3D world. Each representation of a structure may show the structure viewed from a different angle revealing various features of the structure that may not be visible in other representations.

In another embodiment, a user may acquire the right to control the lighting and/or color of multiple buildings. This may allow presentation of more impressive, eye catching messages, across multiple buildings.

In step 305, the media service platform 103 causes, at least in part, a rendering of at least one input connection component, at least one output connection component, at least one connecting user interface element, or a combination thereof for interacting with the at least one user interface element, the one or more media profiles, or a combination thereof. The designation of the UI elements of the virtual display may include accessing and retrieval of information associated with the UI elements, the structures and their features such as regulations (e.g., copyright, parental control, adult content, lottery, gambling, etc.), restrictions (e.g., the number of outputs per windows), agreements (e.g., between media profile owner and the building owner), initial setups (e.g., default settings), etc. that determine the relationship between the UI elements and the structures, between every structure and its features.

In step 307, the media service platform 103 determines one or more interactions among the at least one connecting user interface element, the at least one input connection component, the at least one output connection component, or a combination. In one embodiment, the media service platform 103 may generate interactions among the UI elements, animations and the virtual representation of structures. For example, animated characters, objects, etc. may be added to the presented output to for example interact with other objects (e.g., as a game), advertisements (e.g., banners, etc.), etc.

In step 309, the media service platform 103 causes, at least in part, one or more actions with respect to the one or more media profiles, based on one or more interactions. The one or more actions may include transfer of some or all media profile data, playback media content associated with the media profile, rendering the media content with media processing effects, etc.

The one or more representations are one or more three-dimensional representations, one or more two-dimensional representations, or a combination thereof of the at least one point of interest, one or more structures associated with the at least one point of interest, or a combination thereof.

In one embodiment, the media service platform 103 determines that the one or more interactions are among the at least one input connection component, the at least one connecting user interface element, and one or more applications. The media service platform 103 causes, at least in part, a transfer of media information from the one or more applications to the one or more profiles in response to the one or more interactions. The media information may include or exclude some or all of the media profile data, media content associated with the media profile, recommended/suggested media content (e.g., via Pandora®, MySpace®, etc.), etc. By way of example, the user may get recommendations of new songs to the user's playlist associated with a particular location (e.g., the Stature of Liberty in New York City). The media service platform 103 causes, at least in part, an initiation of a playback of one or more media files associated with the one or more media profiles, the media information, or a combination thereof via the one or more applications based, at least in part, on the transfer.

In one embodiment, the media service platform 103 determines that the one or more interactions are among the at least one output connection component, the at least one connecting user interface element, and one or more applications. The media service platform 103 causes, at least in part, a transfer of the media information from the one or more media profiles to the one or more applications in response to the one or more interactions. By way of example, a user shares the user's playlist consumed at a certain location with the service. The media service platform 103 causes, at least in part, a generation of a request to playback one or more media files at the at least one point of interest based, at least in part, on the transfer. The one or more media files are associated with the media information, the one or more applications, or a combination thereof.

In one embodiment, the media service platform 103 causes, at least in part, a rendering of at least one other user interface element in association with the at least one representation of the at least one point of interest. The at least one other user interface element is associated with performing one or more media processing effects. The at least one other user interface element is rendered with at least one other input connection component, at least one other output connection component, or a combination thereof. The one or more media processing effects are thematically related to the at least one point of interest. These media processing effects may affect the user experience and attract user's attention to a certain content, provided information, etc.

In one embodiment, the media service platform 103 provides animated virtual objects to be added to the virtual representation of the real world. The media service platform 103 checks whether one or more animated objects are introduced. If animated objects are introduced, the media service platform 103 generates at least one animation including the one or more other representations of the one or more objects determined by the interactions among the UI elements. In these and other embodiments, the media service platform 103 may activate applications 109 from the UE 101a-101n, other applications from storage 217, downloadable applications via communication network 105, or a combination thereof to generate and manipulate one or more media processing effects.

It is noted that even though the virtual display is generated based on the structures of the real world and their features, however the digital characteristics of the virtual display enables various modifications on the features such as color, shape, appearance, lighting, etc. The type, level, and method of media processing effects may be determined by one or more applications 109 or by one or more instructions in storage 217 or in the media data 107. For example, the shape and design of the virtual windows may be modified to create an artistic, architectural, historic, social, etc. statement matching the purpose of the presentation.

In one embodiment, the media service platform 103 determines the one or more media files to present in the user interface element based, at least in part, on physical proximity, social proximity, media profile similarity, or a combination thereof.

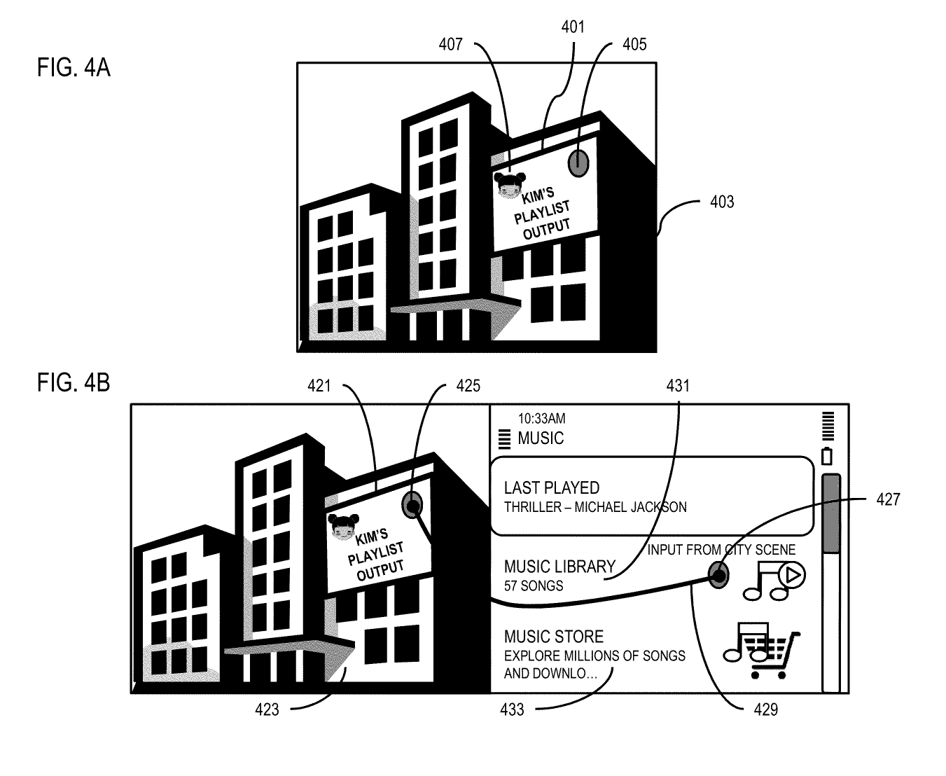

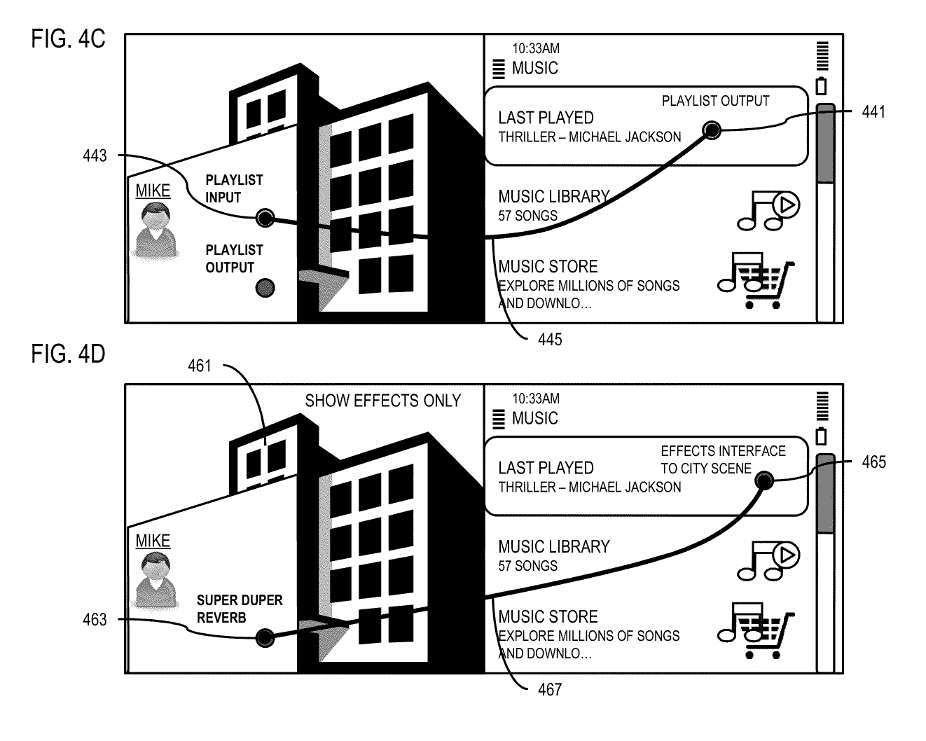

FIGS. 4A-4D show presentation of media-sharing user interface elements on buildings, according to various embodiments. In one embodiment, users of a music service share information about music they consume in certain locations or music they want to associate with the locations. The service gathers the information. It is assumed that the users have at least one music playlist associated with each particular location they have registered to in the service.

A media profile owner (e.g., a user) can acquire the right to place/tag UI elements associated with a media profile on the virtual display of a building, which are displayed to users visiting locations from where the building can be viewed. The media profile owner can find suitable points in a building structure for inserting a playlist and an output, and modifies the building visualizations to depict the playlist and/or the output. For example, in FIG. 4A shows a billboard 401 presented on building 403 where the media profile owner acquiring the right of using the billboard may present its playlist on the billboard 401 according to the agreement with building owner.

Another user starts the application 109 at his/her user device and enables a “music discovery” mode. The other user moves through a 3D mirror world visualization and accesses any location of interest. In a location, the other user can see in the 3D view facades of the building 403 showing a playlist output 405. For privacy reasons, the media profile owner may or may not be physically present in the building.

The building is implemented a 3D object with a skin (a bitmap image) that can be changed. Originally, the skin is based on the photographs of the building. The service modifies the skin of each building so that a thumbnail image of the user's image 407 is shown in the facade of the building 403 next to a virtual music input or output socket UI element 405. As a GUI element, the input/output socket has the functionality that a patch cable from another application (e.g., a music player) to be connected thereto.

Multiple users' playlists and/or output sockets could be shown in a similar manner. If several media profile owners have associated their playlists with the same building 403, these users could be ranked based on their proximity in a social network to the user viewing the building. Thus, only one or more of the closer users, or those users with a music profile matching with the viewing user, may be shown on the building 403.

FIG. 4B shows a user interface set to a split-screen mode for connecting an output 425 of a playlist 421 from a building 423 to an input 427 of a music player application via a cable 429. The music player application can receive/merge the playlist 421 and/or recommendations from other sources into a local playlist. The music player application can receive/merge songs in playlist 421 into a music library 431. The songs may be input via the cable 429 from a media file associated with the playlist 421, from a music store 433, or from the music service, and played to the user (some of the songs may already be stored on the user device).

The connection can be made vice-versa. For example, as shown in FIG. 4C, the user may connect a playlist output 441 to a playlist input 443 of Mike's restaurant & club via a cable 445. In this case, where the user is physically located is not relevant. All the music the user is listening to is fed to the playlist of the club. If the user's playlist is accepted by a person at the club, or the playlist matches the generic music profile defined for the club, the music may be received by a device connected to the loudspeakers in the club, and as a result the music listened by the user is then also played from the loudspeakers at the club.

Any user can have a music recommendation input displayed on a building that allows another user to feed a playlist to the first user's music playlist. In one implementation, the music recommendations may be collected by the music service from the music consumption of the first user, and fed from the service to the second user. In another implementation, the music recommendations may be sent directly from the music player application of the first user to the music player application of the second user. The first device can obtain from the service the address to the second device.

FIG. 4D depicts an audio processing effect associated with a particular location. The audio processing effect may be, for example, a reverberation effect that models the acoustic properties of the building 461. The effect may be created, for example, when visually modeling the building. The processing of the effect may be implemented on the music service.

By way of example, Mike works in the building 461 that has a long hallway which creates a special reverberation effect in the physical world. Mike makes a similar effect available in a media profile associated with the building via an effect input 463 on the side of the building. Another user discovers this effect via the service, and connects his media player audio output 465 to the effect input 463 of the building 461 with a cable 467. The reverberation effect is then applied to the music the other user listens to as long as this connection is active.

In one implementation, the effect algorithm may be copied to the other user's media player application, which then renders the effect during music playback at the other user's device. In another embodiment, the digital music output from the other user's device is fed to the music service that renders the effect and returns the music with the effect to the other user's device, so the connection from music player application to the service is bi-directional. In yet another embodiment, a copy of the music file is stored on the service, the effect is rendered to the music file, and the resulting music file (with effect) is transferred to the other user's device application for playback.

The audio processing effects may be thematically related to the point of interest associated with the building. Thus, on basis of the POI icon, a user device can anticipate what kind of audio processing effect can be accessed from each building. Also, in the case of reverberation effects, the user device can deduce from the size and shape of the building to some extent the reverberation it creates.

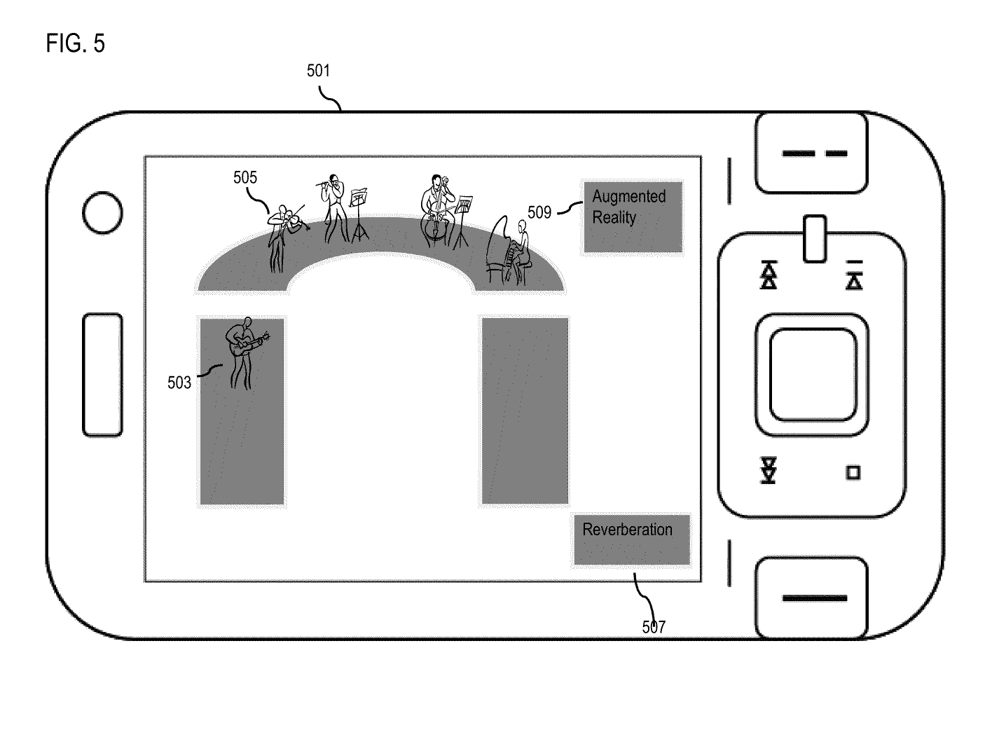

FIG. 5 is diagram of a user interface utilized media processing effects, according to one embodiment. As shown, the example user interface of FIG. 5 includes one or more user interface elements, such as the viewpoints, and/or functionalities created and/or modified based, at least in part, on information, data, and/or signals resulting from the process 300 described with respect to FIG. 3. More specifically, FIG. 5 illustrates a user interface 501 presenting a video clip of a user 503 playing a guitar with a band 505 in a concert hall although the user does not actually play in the concert hall with the band. In addition, a user has the option to present and/or playback the media content by touching a reverberation element 507 and or an augmented reality element 509 in different manners. A user is able to touch or select the reverberation element 507 to simulate the acoustic effect of the user's guitar sound as if playing in the space of the concert hall. The user can touch or select the augmented reality element 509 to argument the simulated video of the user with the band's video.

The above-discussed embodiments combine media discovery and sharing with a city model, to motivate users to discover new media content and share playlists. By way of example, connecting a playlist to a building can influence the media recommendations in that location and/or start playing the playlist with compatible wireless speakers within the location. As another example, connecting to a user's playlist through the output of a physical building would input media content to the user's playlist that are recently listened at that location.

The above-discussed embodiments utilize social networks in media consumption by filing media profiles to be access based on the proximity of users in their social networks. The above-discussed embodiments support users to access media content, feeds media recommendations to the service or other user devices, and defines media processing effects through a 3D environment.

The processes described herein for providing a location-tagged user interface for media sharing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

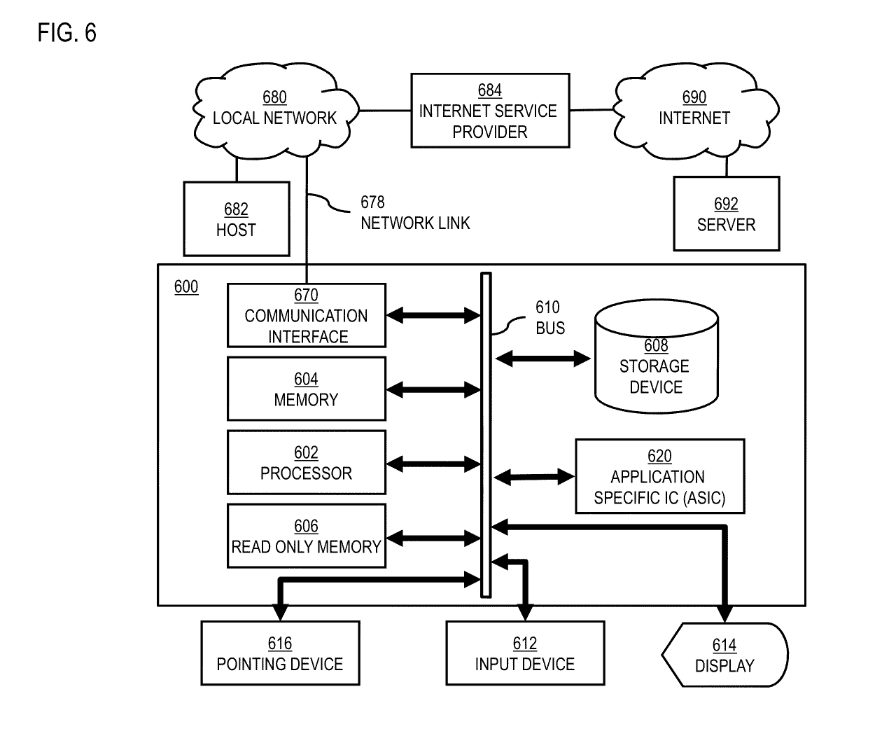

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a location-tagged user interface for media sharing as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a location-tagged user interface for media sharing.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to provide a location-tagged user interface for media sharing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing a location-tagged user interface for media sharing. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a location-tagged user interface for media sharing, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing a location-tagged user interface for media sharing at the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide a location-tagged user interface for media sharing as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing a location-tagged user interface for media sharing.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a location-tagged user interface for media sharing. The memory 705 also stores the data associated with or generated by the execution of the inventive steps.

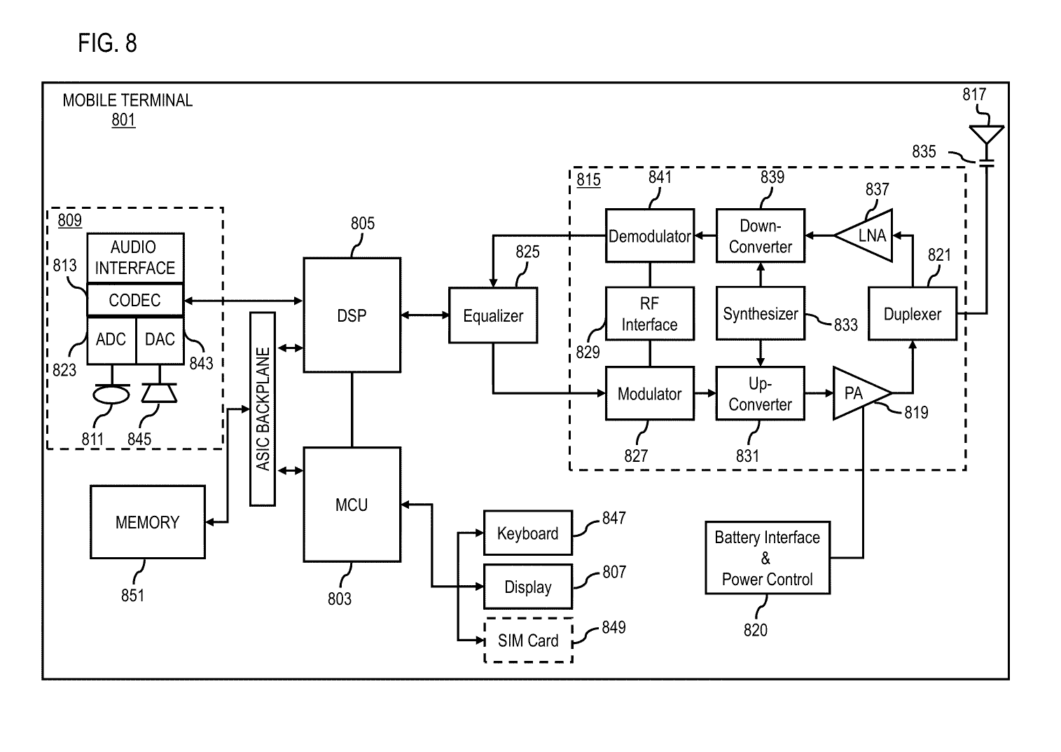

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing a location-tagged user interface for media sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a location-tagged user interface for media sharing. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide a location-tagged user interface for media sharing. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more media profiles associated with at least one point of interest;
a rendering of at least user interface element in association with at least one representation of the at least one point of interest, wherein the user interface element represents, at least in part, the one or more media profiles; and
a rendering of at least one input connection component, at least one output connection component, or a combination thereof for interacting with the at least one user interface element, the one or more media profiles, or a combination thereof.

2. A method of claim 1, wherein the (1) data and/or (2) information and/or (3) at least one signal are further based, at least in part, on the following:
a rendering of at least one connecting user interface element,
wherein one or more interactions among the at least one connecting user interface element, the at least one input connection component, the at least one output connection component, or a combination thereof causes, at least in part, one or more actions with respect to the one or more media profiles.

3. A method of claim 2, wherein the (1) data and/or (2) information and/or (3) at least one signal are further based, at least in part, on the following:
at least one determination that the one or more interactions are among the at least one input connection component, the at least one connecting user interface element, and one or more applications; and
a transfer of media information from the one or more applications to the one or more profiles in response to the one or more interactions.

4. A method of claim 3, wherein the (1) data and/or (2) information and/or (3) at least one signal are further based, at least in part, on the following:
an initiation of a playback of one or more media files associated with the one or more media profiles, the media information, or a combination thereof via the one or more applications based, at least in part, on the transfer.

5. A method of claim 2, wherein the (1) data and/or (2) information and/or (3) at least one signal are further based, at least in part, on the following:
at least one determination that the one or more interactions are among the at least one output connection component, the at least one connecting user interface element, and one or more applications; and
a transfer of the media information from the one or more media profiles to the one or more applications in response to the one or more interactions.

6. A method of claim 5, wherein the (1) data and/or (2) information and/or (3) at least one signal are further based, at least in part, on the following:
a generation of a request to playback one or more media files at the at least one point of interest based, at least in part, on the transfer,
wherein the one or more media files are associated with the media information, the one or more applications, or a combination thereof.

7. A method of claim 1, wherein the (1) data and/or (2) information and/or (3) at least one signal are further based, at least in part, on the following:
a rendering of at least one other user interface element in association with the at least one representation of the at least one point of interest,
wherein the at least one other user interface element is associated with performing one or more media processing effects; and
wherein the at least one other user interface element is rendered with at least one other input connection component, at least one other output connection component, or a combination thereof.

8. A method of claim 1, wherein the one or more processing effects are thematically related to the at least one point of interest.

9. A method of claim 1, wherein the (1) data and/or (2) information and/or (3) at least one signal are further based, at least in part, on the following:
at least one determination of the one or more media files to present in the user interface element based, at least in part, on physical proximity, social proximity, media profile similarity, or a combination thereof.

10. A method of claim 1, wherein the one or more representations are one or more three-dimensional representations, one or more two-dimensional representations, or a combination thereof of the at least one point of interest, one or more structures associated with the at least one point of interest, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine one or more media profiles associated with at least one point of interest;
cause, at least in part, a rendering of at least user interface element in association with at least one representation of the at least one point of interest, wherein the user interface element represents, at least in part, the one or more media profiles; and
cause, at least in part, a rendering of at least one input connection component, at least one output connection component, or a combination thereof for interacting with the at least one user interface element, the one or more media profiles, or a combination thereof.

12. An apparatus of claim 11, wherein the apparatus is further caused to:
cause, at least in part, a rendering of at least one connecting user interface element,
wherein one or more interactions among the at least one connecting user interface element, the at least one input connection component, the at least one output connection component, or a combination thereof causes, at least in part, one or more actions with respect to the one or more media profiles.

13. An apparatus of claim 12, wherein the apparatus is further caused to:
determine that the one or more interactions are among the at least one input connection component, the at least one connecting user interface element, and one or more applications; and
cause, at least in part, a transfer of media information from the one or more applications to the one or more profiles in response to the one or more interactions.

14. An apparatus of claim 13, wherein the apparatus is further caused to:
cause, at least in part, an initiation of a playback of one or more media files associated with the one or more media profiles, the media information, or a combination thereof via the one or more applications based, at least in part, on the transfer.

15. An apparatus of claim 12, wherein the apparatus is further caused to:
determine that the one or more interactions are among the at least one output connection component, the at least one connecting user interface element, and one or more applications; and
cause, at least in part, a transfer of the media information from the one or more media profiles to the one or more applications in response to the one or more interactions.

16. An apparatus of claim 15, wherein the apparatus is further caused to:
cause, at least in part, a generation of a request to playback one or more media files at the at least one point of interest based, at least in part, on the transfer,
wherein the one or more media files are associated with the media information, the one or more applications, or a combination thereof.

17. An apparatus of claim 11, wherein the apparatus is further caused to:
cause, at least in part, a rendering of at least one other user interface element in association with the at least one representation of the at least one point of interest,
wherein the at least one other user interface element is associated with performing one or more media processing effects; and
wherein the at least one other user interface element is rendered with at least one other input connection component, at least one other output connection component, or a combination thereof.

18. An apparatus of claim 11, wherein the one or more processing effects are thematically related to the at least one point of interest.

19. An apparatus of claim 11, wherein the apparatus is further caused to:
determine the one or more media files to present in the user interface element based, at least in part, on physical proximity, social proximity, media profile similarity, or a combination thereof.

20. An apparatus of claim 11, wherein the one or more representations are one or more three-dimensional representations, one or more two-dimensional representations, or a combination thereof of the at least one point of interest, one or more structures associated with the at least one point of interest, or a combination thereof.

21-48. (canceled)
